(19) United States
(12) Patent Application Publication
(10) Pub. No.: US 2011/0153995 A1
(43) Pub. Date: Jun. 23, 2011

(54) ARITHMETIC APPARATUS INCLUDING MULTIPLICATION AND ACCUMULATION, AND DSP STRUCTURE AND FILTERING METHOD USING THE SAME

(75) Inventors: Kyung Jin BYUN, Daejeon (KR); Seong Mo Park, Daejeon (KR); Nak Woong Eum, Daejeon (KR)

(73) Assignee: ELECTRONICS AND TELECOMMUNICATIONS RESEARCH INSTITUTE, Daejeon (KR)

(21) Appl. No.: 12/970,090

(22) Filed: Dec. 16, 2010

(30) Foreign Application Priority Data
Dec. 18, 2009 (KR) 10-2009-0127511
Oct. 29, 2010 (KR) 10-2010-0107023

(51) Int. Cl. G06F 9/302

(52) U.S. Cl. 712/221; 712/E09.017

(57) ABSTRACT

Disclosed are an arithmetic apparatus including MAC calculation, and a DSP structure and a filtering method using the same. The arithmetic apparatus includes: first and second registers storing one or more pieces of n-bit data (n is a natural number); a third register storing one or more pieces of 2n bit data; a multiplier having a first input terminal connected to the first register, a second input terminal connected to the second and third registers, and multiplying an input value of the first input terminal and that of the second input terminal; and an arithmetic-logic unit (ALU) having a first input terminal connected to an output terminal of the multiplier and a second input terminal feedback-connected to an output terminal, adding an input value of the first terminal and that of the second terminal, and having the output terminal connected to the third register.

### CROSS-REFERENCE TO RELATED APPLICATIONS

This application claims the priority of Korean Patent Application Nos. 10-2009-0127511 filed on Dec. 18, 2009 and 10-2010-0107023 filed on Oct. 29, 2010, in the Korean Intellectual Property Office, the disclosures of which are incorporated herein by reference.

### BACKGROUND OF THE INVENTION

1. Field of the Invention

The present invention relates to an arithmetic apparatus including multiplication and accumulation (MAC), and a DSP structure and a filtering method using the same, and more particularly, to an arithmetic apparatus for performing arithmetic operations including MAC calculations, and an arithmetic method and digital filtering method using the same.

2. Description of the Related Art

The amount of digital signals to be processed in a mobile communication system, a digital multimedia device, and the like, tends to be increasing. Thus, in order to effectively cope with the trend, the system or device employs an embedded type digital signal processor (DSP). Besides state-of-art instruments, even home appliances used in daily life are increasingly employ the DSP due to the diversification and complexity of their functions.

However, the DSP applied to a mobile communication system or a digital multimedia device has a complicated algorithm in its application field, having a large amount of calculation to be processed by the DSP, so there is a limitation in implementing the DSP with a general structure. In particular, algorithms having a great deal of filtering calculations to be processed by the DSP by sampling have a huge amount of calculations involved. Thus, in implementing an algorithm accompanying a great deal of filtering processing, a co-processor is added to the DSP to implement the algorithm.

Recent digital multimedia terminals support various applications, so an embedded DSP performs digital signal processing for various application programs. Thus, the amount of resources required varies, depending on application programs.

However, the specifications of the DSP embedded in a system are designed to satisfy specifications required by an application program having the highest complexity among programs upon which processing is to be performed by the DSP. Thus, when processing is performed on a program having a lower complexity, the majority of the resources of the DSP are not required, such that resource utilization and design space utilization are not effective in terms of hardware design. For example, when a co-processor is employed to process an algorithm including a large amount of IIR filter arithmetic operations (or calculations), a large number of hardware resources are added, but when the IIR filtering calculation is not performed, the co-processor is unnecessary, so the overall hardware design is therefore not effective.

MAC is a basic calculation in IIR filtering, and in general, the DSP includes a hardware block for performing the MAC calculation. Thus, there is no problem in performing a program having a low complexity by using the general DSP, but in the case of an algorithm requiring a great deal of IIR filtering, because the algorithm has a high level of complexity, the DSP uses most resources thereof for filtering calculation. Namely, the processing of the algorithm is not effective.

In addition, generally, the implementation of IIR filtering is very simple in digital signal processing, but in order to implement the IIR filtering having the accuracy of a larger number of bits in a 16-bit fixed point number type DSP, a two to four times larger amount of calculation than 16-bit calculation is required.

Thus, when a signal, such as an audio signal, having a relatively high sampling frequency is input and a large amount of IIR filtering needs to be performed, the amount of calculation is drastically increased to occupy the most of the resources of the DSP, not allowing the DSP to process other tasks.

In addition, when IIR filtering is implemented in a fixed point number type DSP, it can be implemented by several commands such as MAC, ADD, Shift, and the like. However, when IIR filtering is implemented in a fixed point number type calculation, if the accuracy'of calculation is degraded in terms of the characteristics of the IIR filter, the characteristics of the filter would change to cause a distorted output signal. Thus, in order to implement IIR filtering in the 16-bit fixed point number type DSP, a filtering calculation is generally performed with 32-bit accuracy in order to increase the accuracy thereof.

### SUMMARY OF THE INVENTION

An aspect of the present invention provides an arithmetic apparatus including MAC calculation, and a DSP structure and a filtering method using the same, and in this case, the MAC arithmetic apparatus can be applicable to a DSP, and an arithmetic method and a filtering calculation method use the apparatus.

According to an aspect of the present invention, there is provided an arithmetic apparatus including: first and second registers storing one or more pieces of n-bit data (n is a natural number); a third register storing one or more pieces of 2n bit data; a multiplier having a first input terminal receiving data stored in the first register and a second input terminal receiving data stored in the second or third register, and multiplying a reception value of the first input terminal and that of the second input terminal; and an arithmetic-logic unit (ALU) having a first input terminal receiving a calculation value from the multiplier, adding the reception value of the first input terminal and that of the second input terminal, and delivering the added value to the third register, wherein a calculation (or an arithmetic operation) value of the ALU is delivered to a second input terminal of the ALU.

The apparatus may further include: a controller determining whether or not the arithmetic apparatus is to be operated and adjusting the number of calculations.

When the arithmetic apparatus performs a pre-set number of calculations, the controller may store the added value of the ALU in the third register.

The reception value of the second input terminal of the ALU may be a calculation result of a previous computation period.

The multiplier may include: a first calculator multiplying upper n bits of the second input terminal and the reception value of the first input terminal; a second calculator multiplying lower n bits of the second input terminal and the reception value of the first input terminal; a shifter downwardly shifting a calculation value of the second calculator by n bits; and a third calculator adding the calculation value of the first calculator and an output value of the shifter.

The apparatus may further include a barrel shifter upwardly or downwardly shifting the calculation result of the multiplier by certain bits.

The certain bits may be previously set in the barrel shifter according to a pre-set operation mode.

The apparatus may further include: a selector delivering data stored in one of the second and third registers to the multiplier according to the number of calculations.

The apparatus may further include: a fourth register having a 2n-bit size and storing the calculation value of the ALU, wherein the calculation value of the ALU may be delivered to the fourth register, and the data stored in the fourth register may be delivered to the second input terminal of the ALU and the third register.

According to another aspect of the present invention, there is provided a digital signal processor (DSP) including: a processing unit performing one or more n-bit calculation (or arithmetic operation); a memory bank storing one or more pieces of n-bit data; an arithmetic apparatus receiving the n-bit data from the memory bank, performing n×2n bit MAC calculation by using the received n-bit data, and outputting a 2n-bit result value; and an internal bus connecting the processing unit, the memory bank, and the calculation device, wherein when a n×2n bit MAC calculation performing command is received, the processing unit controls the arithmetic apparatus to perform n×2n bit MAC calculation.

The arithmetic apparatus may include: first and second registers storing one or more pieces of n-bit data (n is a natural number); a third register storing one or more pieces of 2n bit data; a multiplier having a first input terminal receiving data stored in the first register and a second input terminal receiving data stored in the second or third register, and multiplying a reception value of the first input terminal and that of the second input terminal; and an arithmetic-logic unit (ALU) having a first input terminal receiving a calculation value from the multiplier, adding the reception value of the first input terminal and that of the second input terminal, and delivering the added value to the third register, wherein a calculation (or an arithmetic operation) value of the ALU is delivered to a second input terminal of the ALU.

The apparatus may further include: a controller determining whether or not the arithmetic apparatus is to be operated and adjusting the number of calculations.

The multiplier may include: a first calculator multiplying upper n bits of the second input terminal and the reception value of the first input terminal; a second calculator multiplying lower n bits of the second input terminal and the reception value of the first input terminal; a shifter downwardly shifting a calculation value of the second calculator by n bits; and a third calculator adding the calculation value of the first calculator and an output value of the shifter.

The apparatus may further include: a selector delivering data stored in one of the second and third registers to the multiplier according to the number of calculations.

The 2n-bit data for the n×2n bit MAC calculation of the arithmetic apparatus may be an n×2n bit MAC calculation result value of the arithmetic apparatus and a pre-set initial value.

According to another aspect of the present invention, there is provided a filtering method using an arithmetic apparatus including first and second registers each having an n-bit size, a third register having a size of 2n bit, a multiplier performing n×2n bit multiplication, and a 2n bit arithmetic-logic unit (ALU), including: a storing operation of storing a filter factor value in the first register, storing an input data value in the second register, and storing a filter calculation result value in the third register; a selecting operation of delivering the filter calculation result value stored in the third register or the input data value stored in the second register to the multiplier according to a pre-set order; a multiplying operation of multiplying the filter factor value stored in the first register and the value delivered in the selecting operation by using the multiplier; an accumulating operation of accumulating a result value of the multiplying operation by using the ALU; and a result value storing operation of outputting a result value of the accumulating operation to the exterior and storing the result value in the third register, when the selecting operation, multiplying operation, the accumulating operation, and the result value storing operation are completely performed on all the filter factors stored in the first register, wherein the selecting operation, multiplying operation, the accumulating operation, and the result value storing operation are sequentially repeatedly performed.

When the filter calculation on the values stored in the second and third registers is terminated, the oldest filter calculation result value of the third register may be deleted and the results value of the second accumulating operation may be stored in the third register.

The arithmetic apparatus may further include: a counter, and when the selecting operation, the multiplying operation, and the accumulating operation are performed by using the counter, it is counted such that the filtering method has been performed one time, thus counting the number of times of performing the filtering method, and in the selecting operation, when the number of times of performing the filtering method is smaller than a pre-set performing number, the filter calculation result value stored in the third register may be delivered to the multiplier, and when the number of times of performing the filtering method exceeds the pre-set performing number, the input data value stored in the second register may be delivered to the multiplier.

In the storing operation, a filter factor value to be multiplied to the filter calculation result value stored in the third register and a filter factor value to be multiplied to the input data value stored in the second register may be sequentially stored in the first register.

The multiplying operation may include: a first operation of performing an n×n bit calculation and outputting 3n bits, when the input data value stored in the second register is received; a second operation of performing an n×2n bit calculation and outputting 3n bits, when the filter calculation result value stored in the second register is received; and a third operation of selectively outputting the upper 2n bits of the 3n bit output value in the second operation.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing function blocks of a MAC (multiplication and Accumulation) block of a general fixed point number type digital signal processor (DSP);

FIG. 2 is a flow chart illustrating a MAC calculation process and a data flow using the MAC block of the general fixed point number type DSP;

FIG. 3 is a schematic block diagram showing function blocks of an arithmetic apparatus including a MAC calculation according to an exemplary embodiment of the present invention;

FIG. 4 is a schematic block diagram showing function blocks of a multiplier of the arithmetic apparatus including a MAC calculation according to an exemplary embodiment of the present invention;

FIG. 5 is a schematic block diagram showing the arithmetic apparatus including a MAC calculation according to an exemplary embodiment of the present invention;

FIG. 6 is a schematic block diagram showing function blocks of a DSP using the arithmetic apparatus including a MAC calculation according to an exemplary embodiment of the present invention; and

FIG. 7 is a flow chart illustrating the process of a filtering method using the arithmetic apparatus including a MAC calculation according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

In general, a digital signal processor (DSP) is designed to have a structure for effectively implementing a digital signal processing calculation. Thus, the DSP, in which data and a program bus are separated and a bank of a data memory is separated, includes a MAC (multiplication and accumulation) calculation structure. In particular, the MAC calculation is used with the highest frequency in the digital signal processing calculation, so a MAC calculation block is a typical hardware block essentially included in the DSP.

MAC is used to process such a calculation such as that of Equation 1 shown below:

$$y ( n ) = {\sum }_{n = 0}^{N - 1} h ( n ) x ( n ) \qquad [ Equation 1 ]$$

In Equation 1, y(n) is a MAC calculation result value, and h(n) and x(n) are data for performing calculations.

Equation 1 performs a calculation of resultantly multiplying h(n) and x(n), adding the multiplication result to a previous multiplication result, and continuously accumulating the result, which corresponds to MAC calculation.

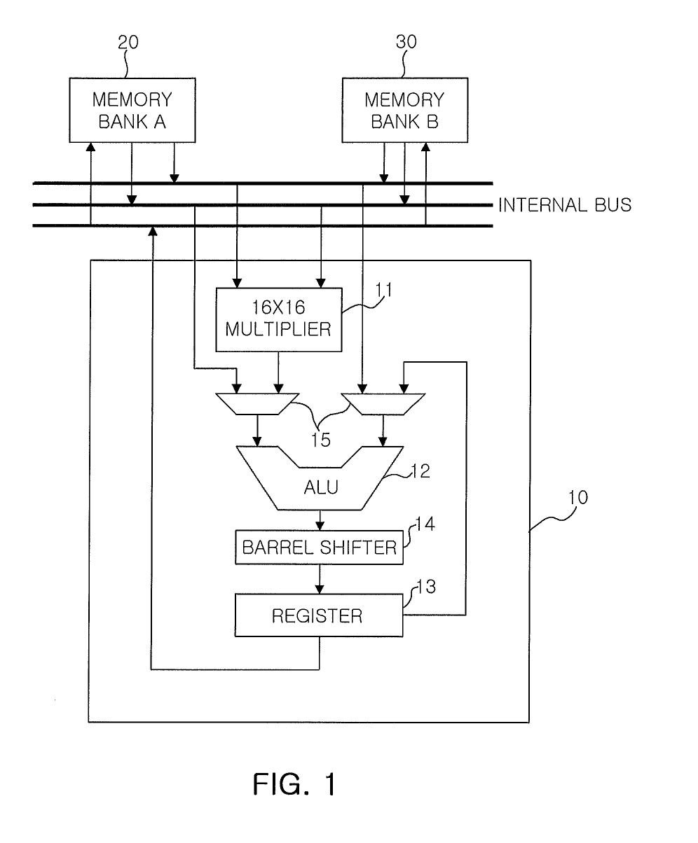

FIG. 1 is a schematic block diagram showing function blocks of a MAC (multiplication and accumulation) block of a general fixed point number type digital signal processor (DSP).

With reference to FIG. 1, a MAC block of a general fixed point number type DSP includes a memory bank A 20, a memory bank B 30, and a MAC device 10.

In particular, the MAC device 10 includes a 16×16 multiplier 11, an arithmetic-logic unit (ALU) 12, and a register 13. The MAC device 10 may further include a selector 15 and a barrel shifter 14.

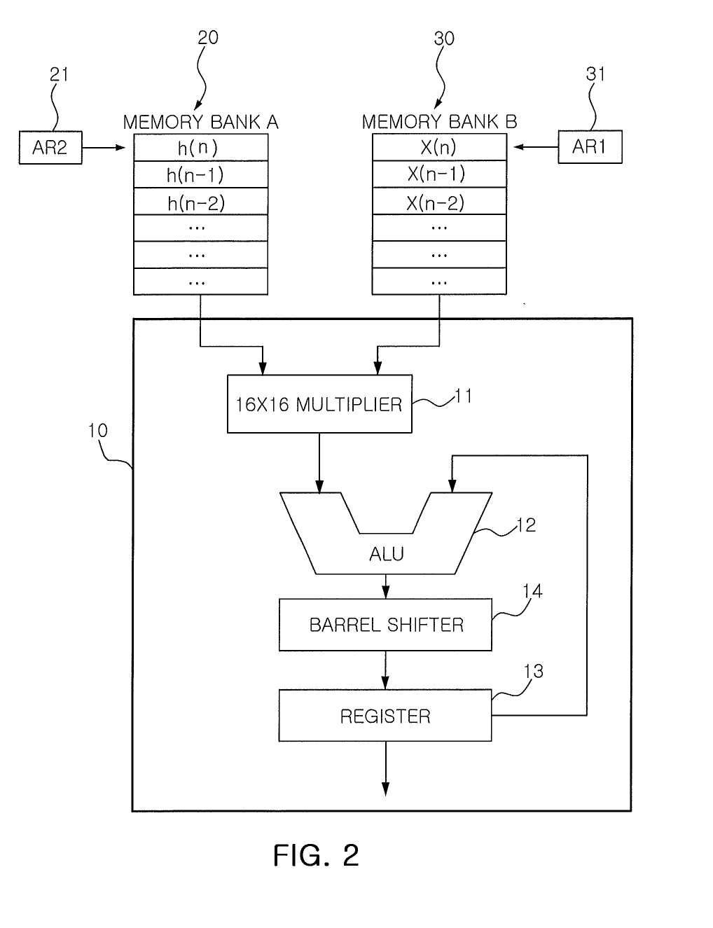

FIG. 2 is a flow chart illustrating a MAC calculation process and a data flow using the MAC block of the general fixed point number type DSP.

A 16-bit MAC calculation process using the function functions will now be described with reference to FIG. 2.

H(n) is stored in the memory bank A 20, and x(n) is stored in the memory bank B 30. The pieces of data stored in the memory banks A and B 20 and 30 are sequentially delivered to the multiplier 11. The multiplier 11 performs multiplication on h(n) and x(n), the ALU 12 performs addition, and the result is stored in the register 13. A multiplication result for the next time is added to the previous value of the register, continuously accumulating the results of the multiplication, resultantly performing the MAC calculation.

The barrel shifter 14 shifts the calculation result value from the ALU 12 upwardly or downwardly by certain bits.

Digital filtering is a typical type of signal processing that requires the foregoing MAC calculation. A secondary IIR filtering calculation process among the digital filtering will now be described.

A transfer function of the secondary IIR filter is represented by Equation 2 shown below:

$$H ( z ) = \frac{{b}_{0} + {b}_{1} {z}^{- 1} + {b}_{2} {z}^{- 2}}{{a}_{0} + {a}_{1} {z}^{- 1} + {a}_{2} {z}^{- 2}} \qquad [ Equation 2 ]$$

The transfer function may be expressed as a difference equation as represented by Equation 3 shown below (here, it is assumed that a0=1).

y(n)=b0*x(n)+b1*x(n−1)+b2*x(n−2)−a1*y(n−1)−a2*y(n−2) [Equation 3]

Here, y(n) is a filter calculation result, x(n) is input data, and b0 to b2, a1 and a2 are filter factor values, corresponding to h(n) in Equation 1

When represented by codes of an assembly level, the secondary IIR filter calculation may include a single multiplication and four MAC calculations.

MPY*(AR1)+,(AR2)+A//b0*x(n)

MAC*(AR1)+,(AR2)+A//b0*x(n)+b1*x(n−1)

MAC*(AR1)+,(AR2)+A//b0*x(n)+b1*x(n−1)+b2*x(n−2)

MAC*(AR1)+,(AR2)+A//b0*x(n)+b1*x(n−1)+b2*x(n−2)+a1*y(n−1)

MAC*(AR1)+,(AR2)+A//b0*x(n)+b1*x(n−1)+b2*x(n−2)+a1*y(n−1)+a2*y(n−2)

In the filtering calculation, the input data, the filter calculation results, and the factor values are all pieces of 16-bit data, and a1 and a2 factor values include a (−) sign and are stored.

The secondary IIR filtering process which is the same as the assembly codes in the 16-bit fixed point number type DSP will now be described with reference to FIG. 2.

The filter factor values b0, b1, b2, a1, and a2 are stored in the memory bank A 20, and the input data and the filter calculation result values x(n), x(n−1), x(n−2), y(n−1), y(n−2) are stored in the memory bank B30.

A register AR2 21 sequentially indicates the filter factor values b0, b1, b2, a1, and a2, stored in the memory bank A 20, and a memory address register AR1 31 sequentially indicates pieces of data x(n), x(n−1), x(n−2), y(n−1), y(n−2) stored in the memory bank B 30. The accumulated final result is stored in the register 13, and the stored pieces of data may be output to the exterior or may be delivered to the memory bank B 30.

When the accuracy of calculation is degraded, a desired filtering result cannot be obtained from the IIR filter calculation. Thus, in general, in the IIR filtering calculation of the 16-bit fixed point number type DSP, y(n−1) and y(n−2) values are calculated with a 32-bit accuracy and stored. Thus, in the assembly codes, a1*y(n−1) and a2*y(n−2) calculation, a (16 bits*16 bits) calculation, must be changed into a (16 bits*32 bits) calculation.

In the 16-bit fixed point number type DSP, a multiplication of the (16 bits*32 bits) accuracy can be obtained through calculation as represented by Equation 4 shown below:

L_{—}32=high1*low2+(low1*low2)>>16 [Equation 4]

Here, high1 is the upper 16 bits of y(n−1) or y(n−1), the filter calculation result value, and low2 is the lower 16 bits of y(n−1) or y(n−2), the filter calculation result value. L_32 is a result value of the (16 bits*32 bits) calculation.

Equation 4 above may be represented by codes of the assembly level as follows.
MPY high_1, low_{—}2, A
MPY low_1, low_{—}2, B
SFTA B, −16
ADD B, A

In order to perform MAC calculation having double accuracy as described above, the calculation capability of the DSP must be considerably consumed. Thus, the DSP in a communication system or a multimedia system operating at a high speed is heavily loaded, causing problems in performing various applications with the DSP.

Thus, the present invention proposes a method of reducing the load of the DSP in which a block that dedicatedly performs the MAC calculation having double accuracy is added to the DSP. Because the block separately performs the MAC calculation which has double accuracy and requires a large amount of calculation, the DSP can secure system resources for performing various applications without having to add a co-processor.

Hereinafter, the arithmetic apparatus which performs the MAC calculation having double accuracy and is added to the DSP, the DSP and a filtering calculation method using the same will now be described.

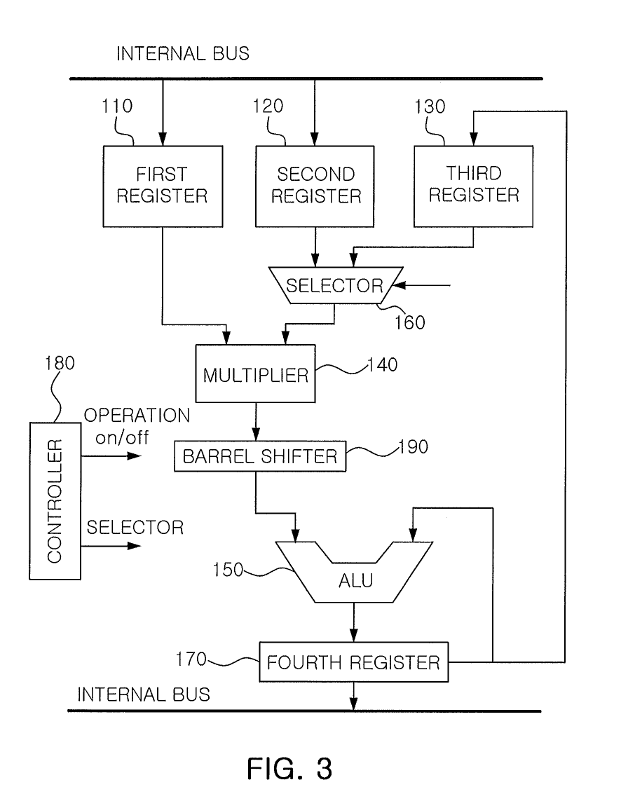

FIG. 3 is a schematic block diagram showing function blocks of an arithmetic apparatus including a MAC calculation according to an exemplary embodiment of the present invention.

With reference to FIG. 3, the arithmetic apparatus 100 including MAC calculation may include first, second, and third registers 110, 120, and 130, a multiplier 140, and an arithmetic-logic unit (ALU) 150. Also, the arithmetic apparatus 100 may further include one or more of a controller 180, a selector 160, a barrel shifter 190, and a fourth register 170.

The first and second registers 110 and 120 may store one or more pieces of n-bit data, and the third register 130 may store one or more pieces of 2n bit data.

The first register 110 may store pieces of n-bit data required for an n bits*2n bits calculation.

The second register 120 may store late pieces of n-bit data required for n bits*n bits calculation. In the present exemplary embodiment, the arithmetic apparatus may also perform the n bits*n bits calculation as well as the n bits*2n bits calculation, and in this case, in order to store pieces of 16-bit data after the n bits n bits calculation, the second register 120 may be used.

The third register 130 may store pieces of 2n-bit data required for the n bits*2n bits calculation.

The multiplier 140 may support the n bits*2n bits calculation. In the present exemplary embodiment, the multiplier 140 is able to perform n bits*2n bits calculation, so it can also support n bits*n bits calculation. A detailed structure of the multiplier 140 will be described later.

The ALU 150 is a device for adding the two input pieces of 2n-bit data. In general, the ALU supports various arithmetic logic calculations, but in the present invention, it may be implemented to have only the addition function for an accumulative addition.

The arithmetic apparatus performing calculations including the MAC calculation according to an exemplary embodiment of the present invention will now be described by using the foregoing elements.

The multiplier 140 requires two, input values, so it receives two pieces of data by using first and second input terminals. In the multiplier 140 according to the present exemplary embodiment, a first input terminal may be connected to the first register 110, and a second input terminal may be connected to the second register 120 or the third register 130. When the second input terminal of the multiplier 140 is connected to the second register 120, the arithmetic apparatus according to the present exemplary embodiment may perform the n bits*n bits calculation, and when the second input terminal of the multiplier 140 is connected to the third register 130, the arithmetic apparatus according to the present exemplary embodiment may perform the n bits*2n bits calculation.

The ALU 150 also requires two input values, so it receives two pieces of data by using first and second input terminals. The ALU 150 according to the present exemplary embodiment is connected to an output terminal of the multiplier 140 to receive a multiplication calculation result value from the multiplier 140. Also, the second input terminal of the ALU 150 is feedback-connected to an output terminal of the ALU 150 to receive an addition calculation result value of the ALU 150.

Because the ALU 150 receives the output value, it can accumulatively add input data. In particular, when the ALU 150 is operated according to a system clock, an input value input to the second input terminal of the ALU 150 may be a result value obtained by being added in a previous period.

Also, when the MAC calculation is terminated, the output terminal of the ALU 150 and the third register 3130 are connected in order to store the output value of the ALU 150 in the third register 130.

In this manner, the arithmetic apparatus 100 according to the present exemplary embodiment performs the MAC calculation by connecting the first to third registers 110 to 130, the multiplier 140, and the ALU 150 as described above.

The selector 160 connects the second register 120 or the third register 130 to the multiplier 140. The selector 160 may select a piece of data input to the second input terminal of the multiplier 140 in order to determine whether or not the arithmetic apparatus 100 should perform the n bits*n bits calculation or the n bits*2n bits calculation.

The fourth register 170 may temporarily store the addition result value of the ALU 150. The addition result value of the ALU 150 may be temporarily stored in the fourth register 170 and then fed back to the second input terminal of the ALU 150.

The controller 180 may determine whether or not the arithmetic apparatus 100 should carry out an operation, checks the number of calculations performed by the arithmetic apparatus 100, and controls the arithmetic apparatus 100 to perform calculation by a pre-set number of times. Also, the controller 180 may control the selecting operation of the selector 160 according to the number of calculations.

Namely, the controller 180 may control the arithmetic apparatus 100 to perform the n bits n bits MAC calculation or the n bits*2n bits MAC calculation, or to perform the n bits*n bits MAC calculation or the n bits*2n bits MAC calculation together.

The barrel shifter 190 may shift an output from the multiplier 140 upwardly or downwardly by certain bits. Namely, the barrel shifter 190 may change the size of the data output from the multiplier 140. Also, the barrel shifter 190 may vary the number of bits to be upwardly or downwardly shifted according to a pre-set operation mode, or previously set the number of bits to be upwardly or downwardly shifted according to a pre-set mode.

When the foregoing arithmetic apparatus 100 is used for the filtering calculation, the n-bit filter factor value is stored in the first register 110, the n-bit input data is stored in the second register 120, and the 2n-bit filter calculation result value is stored in the third register 130. Namely, when the arithmetic apparatus 100 according to the present exemplary embodiment is in use, the MAC digital filtering calculation, having double accuracy, can be implemented by using only a single arithmetic apparatus.

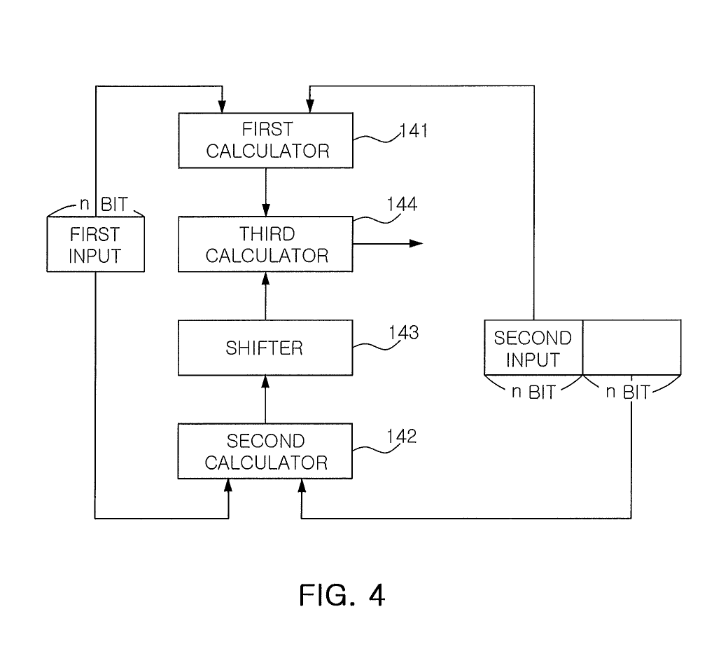

FIG. 4 is a schematic block diagram showing function blocks of a multiplier of the arithmetic apparatus including a MAC calculation according to an exemplary embodiment of the present invention.

With reference to FIG. 4, the multiplier 140 performing n×2n bit multiplication in the n-bit DSP may include a first calculator 141, a second calculator 142, a shifter 143, and a third calculator 144.

The first calculator 141 multiplies an upper n-bit value of a piece of data input to the second input terminal of the multiplier 140 and an n-bit data value input to the first input terminal.

The second calculator 142 multiplies an upper n-bit value of a piece of data input to the second input terminal of the multiplier 140 and an n-bit data value input to the first input terminal.

The shifter 143 may downwardly shift the calculation value of the second calculator 142.

The third calculator 144 adds the calculation value of the first calculator 141 and the output value of the barrel shifter 143.

The multiplier 140 configured as described above according to an exemplary embodiment of the present invention may perform the n*2n bits calculation like assembly codes below:
MPY high_1, low_2, A
MPY low_1, low_2, B
SFTA B, −16
ADD B, A

When the multiplier 140 according to an exemplary embodiment of the present invention performs the n*n bits calculation, it may perform the calculation by using only the first calculator 141 and the third calculator 144.

Because there is no calculator for processing 2n bits, the multiplier 140 performing the n×2n bits multiplication is implemented by using a plurality of n-bit calculators.

The foregoing multiplier 140 may be applied to the arithmetic apparatus according to an exemplary embodiment of the present invention, but in order to improve the speed and efficiency of the arithmetic apparatus, the multiplier 140 performing the n×2n bits multiplication is preferably designed and applied to the arithmetic apparatus. Also, in the multiplier 140 performing the n×2n bits multiplication, only n bits are input to the input terminal, to which 2n bits are to be input, and upper n bits may be filled with 0.

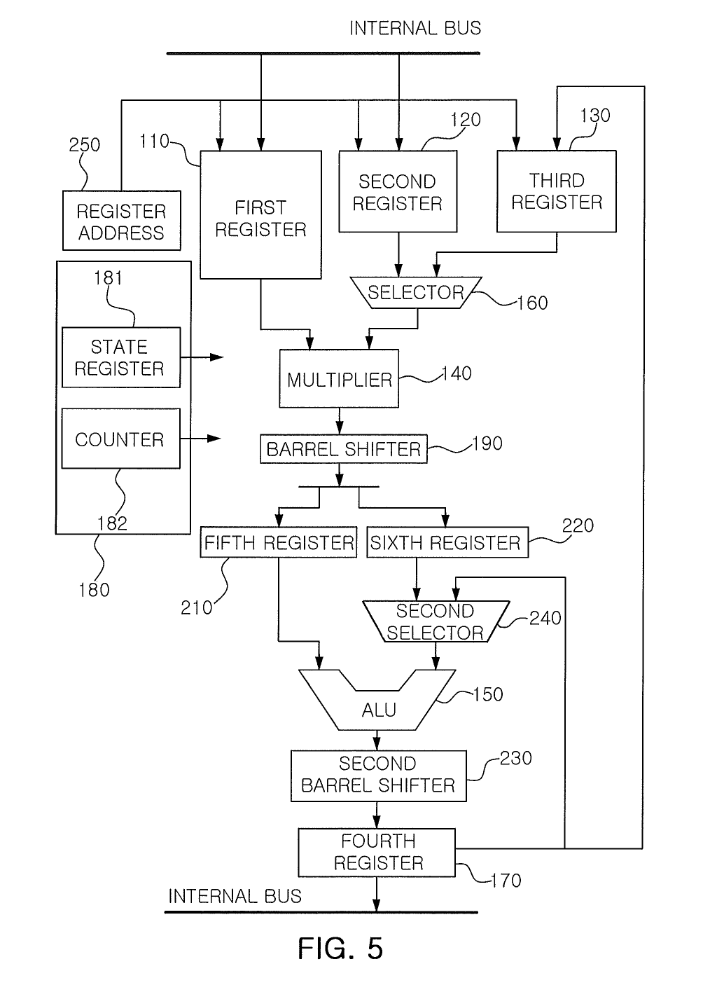

FIG. 5 is a schematic block diagram showing the arithmetic apparatus, including a MAC calculation according to an exemplary embodiment of the present invention. With reference to FIG. 5, the arithmetic apparatus according to an exemplary embodiment of the present invention may include the first to third registers 110 to 130, the multiplier 140, the ALU 150, the controller 180, the selector 160, the barrel shifter 190, and the fourth register 170. Also, the arithmetic apparatus according to an exemplary embodiment of the present invention may further include fifth and sixth registers 210 and 220 that store pieces of 2n-bit data, and also further include a second selector 240, a second barrel shifter 230, or a register address 250.

The elements which may be additionally included serve to increase the degree of freedom of the operation of the arithmetic apparatus 100 or the stability of data transmission. An example thereof will now be described.

The controller 180 according to the present exemplary embodiment may be configured to include a state register 181 and a counter 182. Whether or not to operate the arithmetic apparatus 100 may be determined, or whether or not to output data stored in the fourth register 170 to the exterior may be determined, based on a value stored in the state register 181. When the number of performing the MAC calculation by the arithmetic apparatus 100 is terminated as a one-time accumulative addition, the counter 182 may check that the calculation has been performed one time. Also, the selecting operation by the selector 160 may be controlled by using data stored in the counter 182.

The register address 250 may serve to select a piece of data to be delivered to the multiplier 140, among pieces of data stored in the first to third registers 110, 120, and 130.

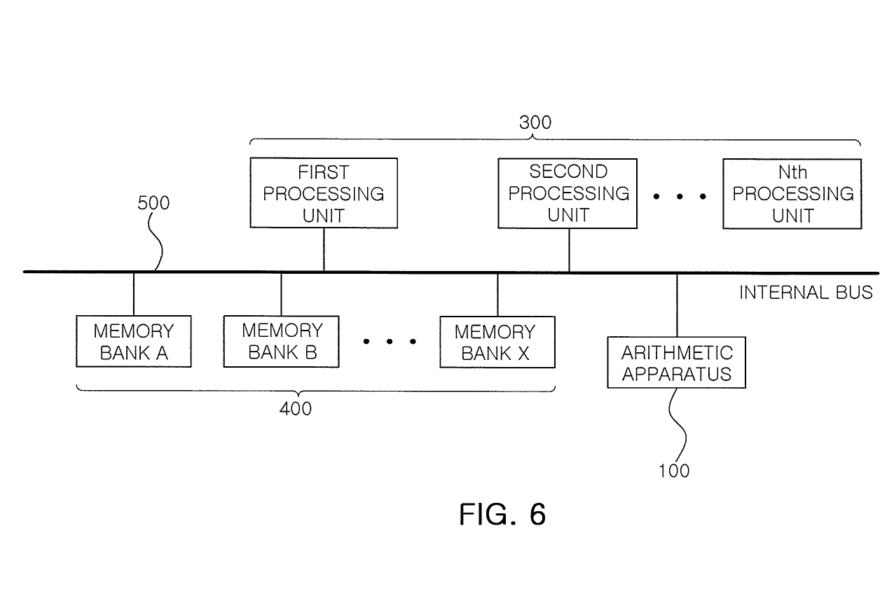

FIG. 6 is a schematic block diagram showing function blocks of a DSP using the arithmetic apparatus including a MAC calculation according to an exemplary embodiment of the present invention.

With reference to FIG. 6, the DSP according to an exemplary embodiment of the present invention may be configured to include one or more processing units 300, one or more memory banks 400, and the arithmetic apparatus 100. The DSP may further include an internal bus 500 for connecting the processing units 300, the memory banks 400, and the arithmetic apparatus 100.

The DSP according to an exemplary embodiment of the present invention may perform a plurality of applications. In case of performing a filtering operation, or the like, that requires a large amount of calculation, the arithmetic apparatus 100, rather than the processing units 300, processes it, thus reducing the load of the processing units 300. Data required for the filtering operation may be delivered to the arithmetic apparatus 100 via the internal bus 500 from the memory banks 400 or the exterior.

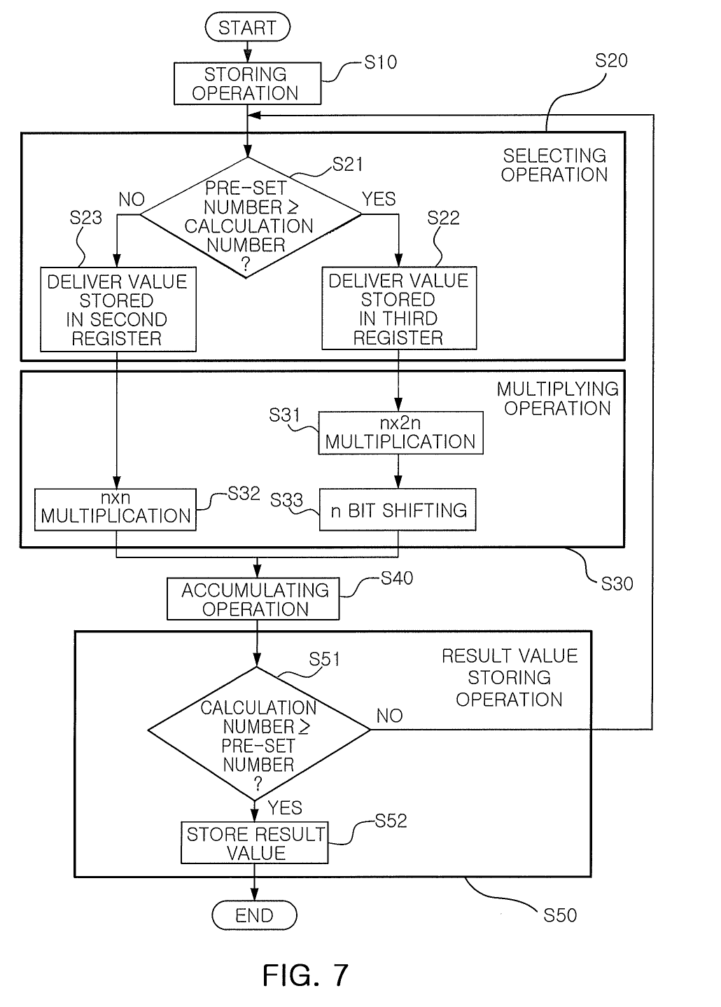

FIG. 7 is a flow chart illustrating the process of a filtering method using the arithmetic apparatus including a MAC calculation according to an exemplary embodiment of the present invention.

The filtering method according to an exemplary embodiment of the present invention may be performed by using the arithmetic apparatus 100 including the first and second registers 110 and 120 each having the size of n bits, the third register 130 having the size of 2n bits, the multiplier 140 performing n×2n bits multiplication, and the 2n-bit ALU 150.

The filtering method according to an exemplary embodiment of the present invention may include a storing step S10, a selecting step S20, a multiplying step S30, an accumulating step S40, and a result value storing step S50.

In the storing step S10, a filter factor value may be stored in the first register 110, an input data value may be stored in the second register 120, and a filter calculation result value may be stored in the third register 130. Namely, in the storing step S10, an n-bit filter factor value is stored in the first register 110, the n-bit input data is stored in the second register 120, and the 2n-bit filter calculation results value is stored in the third register 130.

In particular, in the storing step S10, a filter factor value to be multiplied with the filter calculation result value stored in the third register 130 and a filter factor value to be multiplied with the input data value stored in the second register 120 may be sequentially stored in the first register 110. Accordingly, the arithmetic apparatus 100 can be simply implemented without using the register address 250, or the like, and thus, hardware can be simplified. Also, because a process of designating the position of data stored in the first to third registers 110 to 130 and reading the same is not performed, the filtering method is simple.

In the selecting step S20, the filter calculation result value stored in the third register 130 or the input data value stored in the second register 120 are delivered to the multiplier according to a pre-set order.

In the multiplying step S30, the filter factor value stored in the first register 110 and the value delivered in the selecting step S20 are multiplied by using the multiplier 140.

In particular, the multiplying step S30 may include: a first step (S32) of performing an n*n bit calculation and outputting 2n bits, when the input data value stored in the second register 120 is received (step S23), a second step (S31) of performing an n×2n bit calculation and outputting 3n bits, when the filter calculation result value stored in the third register 130 is received (step S22); and a third step (S33) of selectively outputting the upper 2n bits of the 3n bit output value in the second step.

In the accumulating step S40, a result value of the multiplying operation is accumulated by using the ALU 150.

In the result value storing step S50, when the selecting step, the multiplying step, and the accumulating step (steps S20, S30, and S40) are completely performed on all the filter factors stored in the first register 110, a result value of the accumulating step S40 is output to the exterior and stored in the third register 130.

The filtering calculation method may be performed on all the filter factor values stored in the first register 110 by sequentially repeatedly performing the selecting step, the multiplying step, the accumulating step, and the result value storing step (step S20 to S50).

The arithmetic apparatus 100 further includes the counter 182, and when the selecting step, the multiplying step, the accumulating step, and the result value storing step (step S20 to S50) are performed, the number of times of performing the filtering method may be counted such that the filtering method has been performed once, by using the counter 182.

Also, in the selecting step S20, when the number of times of performing the filtering method is smaller than a pre-set performing number (step S21), the filter calculation result value stored in the third register 130 is delivered to the multiplier 140 (step S22). And, in the selecting step (S20), when the number of times of performing the filtering method exceeds the pre-set performing number (step S21), the input data value stored in the second register 120 is delivered to the multiplier 140 (step S23).

The IIR filtering process with respect to 16 input data according to an exemplary embodiment of the present invention will now be described with reference to FIGS. 3, 4, and 7.

In the storing step S10, before starting IIR filtering calculation, the DSP sequentially stores five filter factor values b0, b1, b2, a1, and a2 in the first register 110. Likewise, the input data x(n), x(n−1), and x(n−2) are stored in the second register 120, and the filter calculation result values y(n−1) and y(n−2) are stored in the third register 130. In case of a first filter calculation with respect to a corresponding input, x(n−1), x(n−2), y(n−1), y(n−2) are set as 0 as an initial setup.

In case of a secondary IIR filter, because a total of five multiplications are performed, so the counter 182 is set to 5. An initial value of the state register 181 is set to a binary value 00. In order for the DSP to inform the state register 181 that data for filter calculation is ready, a binary value 01 is used. When the binary value of the state register 181 is 01, the arithmetic apparatus 100 starts a filtering calculation, and when the filtering calculation is finished, the arithmetic apparatus 100 changes the binary value into 10 to inform the DSP that the filtering calculation has been finished. When the value of the register 181 is 10, the DSP recognizes that the filtering calculation has been finished, reads the final result, and stores it in the memory bank 400.

The register address 250 designates data delivered to the multiplier 140 from the first to third registers 110 to 130.

The secondary IIR filtering calculation process having 32-bit accuracy of Equation 3 is as follows.

The flow of performing the selecting step, the multiplying step, the accumulating step, and the result value storing step (step S20 to S50) after the storing step S10 is performed will now be described.

A first calculation is as follows.

In the selecting step S20, the selector 160 delivers the y(n−1) value stored in the third register to the multiplier 140.

In the multiplying step (S30), a1*y(n−1) calculation is performed, namely, a calculation of 16 bits*32 bits is performed and stored in the fifth register 210.

A second calculation is as follows.

After performing the selecting step S20, in the multiplying step S30, a2*y(n−2) calculation is performed, namely, a calculation of 16 bits*32 bits is performed and stored in the sixth register 220. In this case, in the multiplier 140 or in the barrel shifter 190, the results of 16 bits*32 bits multiplication result is shifted to the right and then output, so only MSB 32 bits are stored in the fifth and sixth registers 210 and 220.

In the accumulating step S40, the ALU 150 receives the values stored in the fifth and sixth registers 310 and 320, performs 32 bits+32 bits addition, and stores the result in the fourth register 170.

In this case, the second selector 240 delivers the value stored in the sixth register 220 to the ALU 150.

The value stored in the fourth register 170 is a1*y(n−1)+a2*y(n−2).

In the result value storing step S50, because the filtering calculation does not reach five times, the steps are repeatedly performed starting from the selecting step S20.

A third calculation is as follows.

In the selecting step S20, the selector 160 delivers the x(n) value stored in the second register to the multiplier 140.

In the multiplying step S30, b0*x(n) calculation, namely, a 16 bits*16 bits multiplication is performed and stored in the fifth register 210.

In the accumulating step S40, the ALU 150 receives values stored in the fifth and fourth registers 210 and 170, performs 32 bits+32 bits addition, and stores the corresponding value in the fourth register 170. In this case, the second selector 240 delivers the value stored in the fourth register 170 to the ALU 150.

In the result value storing step S50, because the filtering calculation does not reach five times, the steps are repeatedly performed starting from the selecting step S20.

In fourth and fifth calculations, the third calculation process is repeatedly performed. In the fifth calculation process, a value stored in the fourth register 170 after the accumulating step S40 is b0*x(n)+b1*x(n−1)+b2*x(n−2)+a1*y(n−1)+a2*y(n−2). Namely, it is the filter calculation result value.

Also, in the fifth calculation, because the number of filtering calculations is five times that of the result value storing step S50, a binary value ‘10’ is written in the state register 181.

Only the upper 16 bits of the value stored in the fourth register 170 may be transmitted to the memory bank 400 or the processing unit 300 through an internal bus, or the overall 32 bits may be transmitted to the memory bank 400 or the processing unit 300. However, the overall 32-bit result of the filter calculation result values y(n−1) and y(n−2) is stored in the third register 130.

It is partially different from the method illustrated in FIG. 7. This is because the filtering method is more simplified by using the fifth and sixth registers 210 and 220.

As set forth above, in the arithmetic apparatus including MAC calculation, and the DSP structure and the filtering method using the same according to exemplary embodiments of the invention, an MAC operation having double accuracy can be performed. Thus, when a signal processing algorithm including a great deal of precise MAC operation is implemented, the amount of resource consumption of the DSP can be reduced and the overall calculation capability of the DSP can be improved.

In addition, an IIR filter having double accuracy can be effectively designed.

While the present invention has been shown and described in connection with the exemplary embodiments, it will be apparent to those skilled in the art that modifications and variations can be made without departing from the spirit and scope of the invention as defined by the appended claims.

What is claimed is:

1. An arithmetic apparatus comprising:
first and second registers storing one or more pieces of n-bit data (n is a natural number);
a third register storing one or more pieces of 2n bit data;
a multiplier having a first input terminal receiving data stored in the first register and a second input terminal receiving data stored in the second or third register, and multiplying a reception value of the first input terminal and that of the second input terminal; and
an arithmetic-logic unit (ALU) having a first input terminal receiving a calculation value from the multiplier, adding the reception value of the first input terminal and that of the second input terminal, and delivering the added value to the third register,
wherein a calculation value of the ALU is delivered to a second input terminal of the ALU.

2. The apparatus of claim 1, further comprising:
a controller determining whether or not the arithmetic apparatus is to be operated and adjusting the number of calculations.

3. The apparatus of claim 2, wherein when the arithmetic apparatus performs a pre-set number of calculations, the controller stores the added value of the ALU in the third register.

4. The apparatus of claim 1, wherein the reception value of the second input terminal of the ALU is a calculation result of a previous computation period.

5. The apparatus of claim 1, wherein the multiplier comprises:
a first calculator multiplying upper n bits of the second input terminal and the reception value of the first input terminal;
a second calculator multiplying lower n bits of the second input terminal and the reception value of the first input terminal;
a shifter downwardly shifting a calculation value of the second calculator by n bits; and
a third calculator adding the calculation value of the first calculator and an output value of the shifter.

6. The apparatus of claim 1, further comprising:
a barrel shifter upwardly or downwardly shifting the calculation result of the multiplier by certain bits.

7. The apparatus of claim 6, wherein the certain bits are previously set in the barrel shifter according to a pre-set operation mode.

8. The apparatus of claim 1, further comprising:
a selector delivering data stored in one of the second and third registers to the multiplier according to the number of calculations.

9. The apparatus of claim 1, further comprising:
a fourth register having a 2n-bit size and storing the calculation value of the ALU,
wherein the calculation value of the ALU is delivered to the fourth register, and the data stored in the fourth register is delivered to the second input terminal of the ALU and the third register.

10. A digital signal processor (DSP) comprising:
a processing unit performing one or more n-bit calculation (or arithmetic operation);
a memory bank storing one or more pieces of n-bit data;
an arithmetic apparatus receiving the n-bit data from the memory bank, performing n×2n bit MAC calculation by using the received n-bit data, and outputting a 2n-bit result value; and
an internal bus connecting the processing unit, the memory bank, and the calculation device,
wherein when a n×2n bit MAC calculation performing command is received, the processing unit controls the arithmetic apparatus to perform n×2n bit MAC calculation.

11. The processor of claim 10, wherein the arithmetic apparatus comprises:
first and second registers storing one or more pieces of n-bit data (n is a natural number);
a third register storing one or more pieces of 2n bit data;
a multiplier having a first input terminal receiving data stored in the first register and a second input terminal receiving data stored in the second or third register, and multiplying a reception value of the first input terminal and that of the second input terminal; and
an arithmetic-logic unit (ALU) having a first input terminal receiving a calculation value from the multiplier, adding the reception value of the first input terminal and that of the second input terminal, and delivering the added value to the third register,
wherein a calculation value of the ALU is delivered to a second input terminal of the ALU.

12. The processor of claim 11, further comprising:
a controller determining whether or not the arithmetic apparatus is to be operated and adjusting the number of calculations.

13. The processor of claim 11, wherein the multiplier comprises:
a first calculator multiplying upper n bits of the second input terminal and the reception value of the first input terminal;
a second calculator multiplying lower n bits of the second input terminal and the reception value of the first input terminal;
a shifter downwardly shifting a calculation value of the second calculator by n bits; and
a third calculator adding the calculation value of the first calculator and an output value of the shifter.

14. The processor of claim 11, wherein the apparatus may further include: a selector delivering data stored in one of the second and third registers to the multiplier according to the number of calculations.

15. The processor of claim 10, wherein the 2n-bit data for the n×2n bit MAC calculation of the arithmetic apparatus is an n×2n bit MAC calculation result value of the arithmetic apparatus and a pre-set initial value.

16. A filtering method using an arithmetic apparatus including first and second registers each having an n-bit size, a third register having a size of 2n bit, a multiplier performing n×2n bit multiplication, and a 2n bit arithmetic-logic unit (ALU), the method comprising:
a storing operation of storing a filter factor value in the first register, storing an input data value in the second register, and storing a filter calculation result value in the third register;
a selecting operation of delivering the filter calculation result value stored in the third register or the input data value stored in the second register to the multiplier according to a pre-set order;
a multiplying operation of multiplying the filter factor value stored in the first register and the value delivered in the selecting operation by using the multiplier;
an accumulating operation of accumulating a result value of the multiplying operation by using the ALU; and
a result value storing operation of outputting a result value of the accumulating operation to the exterior and storing the result value in the third register, when the selecting operation, the multiplying operation, the accumulating operation, and the result value storing operation are completely performed on all the filter factors stored in the first register,
wherein the selecting operation, multiplying operation, the accumulating operation, and the result value storing operation are sequentially repeatedly performed.

17. The method of claim 16, wherein when the filter calculation on the values stored in the second and third registers is terminated, the oldest filter calculation result value of the third register is deleted and the results value of the second accumulating operation may be stored in the third register.

18. The method of claim 16, wherein the arithmetic apparatus further comprises a counter, and when the selecting operation, the multiplying operation, and the accumulating operation are performed by using the counter, it is counted such that the filtering method has been performed one time, thus counting the number of times of performing the filtering method, and in the selecting operation, when the number of times of performing the filtering method is smaller than a pre-set performing number, the filter calculation result value stored in the third register is delivered to the multiplier, and when the number of times of performing the filtering method exceeds the pre-set performing number, the input data value stored in the second register is delivered to the multiplier.

19. The method of claim 16, wherein, in the storing operation, a filter factor value to be multiplied to the filter calculation result value stored in the third register and a filter factor value to be multiplied to the input data value stored in the second register are sequentially stored in the first register.

20. The method of claim 16, wherein the multiplying operation comprises:
a first operation of performing an n×n bit calculation and outputting 2n bits, when the input data value stored in the second register is received;
a second operation of performing an n×2n bit calculation and outputting 3n bits, when the filter calculation result value stored in the third register is received; and
a third operation of selectively outputting the upper 2n bits of the 3n bit output value in the second operation.
